(19) United States
(12) Patent Application Publication
(10) Pub. No.: US 2023/0345090 A1
(43) Pub. Date: Oct. 26, 2023

(54) SYSTEMS AND METHODS FOR GENERATING SUMMARY MEDIA CONTENT BASED ON BIOMETRIC INFORMATION

(71) Applicant: DISH Network L.L.C., Englewood, CO (US)

(72) Inventor: Jesus Flores Guerra, Denver, CO (US)

(21) Appl. No.: 17/729,995

(22) Filed: Apr. 26, 2022

(51) Int. Cl. H04N 21/8549; H04N 21/442; H04N 21/422; H04N 21/45

(52) U.S. Cl. CPC H04N 21/8549; H04N 21/44218; H04N 21/42201; H04N 21/4532

(57) ABSTRACT

A method of generating summary media content includes providing media content by an electronic device and identifying one or more periods of high user engagement with the media content. The one or more periods of high user engagement are identified by obtaining biometric information, via one or more biometric sensors, from a user while the user interacts with the media content. Based on the biometric information, at least one media content portion is isolated from the media content and is used to generate summary media content.

### TECHNICAL FIELD

The present disclosure relates to generating summary media content and, in particular, to generating customized summary media content based on a user interaction with provided media.

### BACKGROUND

The typical consumer engages and interacts with entertainment through a number of different media sources, including television and film, radio, personal computing electronics, and print. In modern society, media is typically provided as mass media and is designed to be interacted with by a large number of people. Mass media may refer to television broadcasting, which may provide a television program to an audience ranging from the dozens to the millions, depending on the popularity of the program.

As mass media is intended to distribute media to a group of people, individuals tend to consume identical content. For example, a news article for publication will be the same across all individual newspapers printed for mass use. As another example, a particular television program will be the same regardless of what specific device a consumer uses to watch the program.

Highlight reels, or simply “highlights,” are a form of media content that a consumer may interact with. Highlights are designed to summarize a longer-form of media or to attract a consumer's attention. Highlights may be in the form of sports highlights, where important moments in a match or game are captured and presented in a condensed format, or in the form of a trailer, teaser, or commercial, where movie or television show moments are presented to a consumer as a form of advertisement and to spark a user's curiosity about the full program.

However, as discussed above with respect to mass media, highlights are intended for wide distribution. Highlights are created manually at, for example, a television station or production studio, are distributed to various media distributors, and, ultimately, are viewed by the consumer population. Each consumer, therefore, interacts with highlights that are identical to highlights distributed amongst a larger group. Mass produced highlights, by virtue of being intended for a large audience, may not be sufficient, however, to cater to individual consumers' tastes and may cause those individual consumers to lose interest in the referenced material.

### SUMMARY

This summary is provided to introduce a selection of concepts in a simplified form, as further described below in the Detailed Description section. This summary is not intended to identify key or essential features of the claimed subject matter, nor is it intended to be used as an aid in determining the scope of the claimed subject matter.

Disclosed herein are devices, systems, and methods for generating summary media content based on a user's biometric information.

Embodiments described herein generally relate to a method of generating summary media content. Such a method may comprise outputting, by an electronic device, media content for display to a user, receiving, by the electronic device, biometric information of the user from a biometric sensor while the media content is output for display, and identifying, by the electronic device, one or more periods of high user engagement with the media content based on the biometric information received from the biometric sensor, the one or more periods of high user engagement associated with at least one media content portion of the media content. The method may further comprise isolating, by the electronic device, the at least one media content portion from the media content, generating, by the electronic device, summary media content including the at least one isolated media content portion, and outputting, by the electronic device, the summary media content for display.

According to some embodiments, identifying the one or more periods of high user engagement may comprise determining, by the electronic device, when the biometric information of the user reaches a threshold value. In accordance with the biometric information of the user reaching the threshold value, the method may further comprise identifying, by the electronic device, the one or more periods of high user engagement.

In some cases, the biometric sensor may be an optical sensor configured to detect a certain facial expression of the user and the one or more periods of high user engagement may correspond to periods when the user is exhibiting the certain facial expression. The certain facial expression of the user may correspond to at least one of: happiness, sadness, anger, excitedness, or surprise.

In some cases, the biometric sensor may be a heartrate monitor configured to monitor a heartrate of the user and the one or more periods of high user engagement may correspond to periods when the user is experiencing an elevated heartrate.

Outputting the summary media content for display may comprise outputting, by the electronic device, the summary media content for display when the user interacts with a graphical representation of the media content. The method may further comprise, with respect to a user profile of the user, associating, by the electronic device, the summary media content with the media content. When the user profile of the user is active, the method may further comprise outputting, by the electronic device, the summary media content, or a portion thereof, in response to an interaction with the media content.

The user may be associated with user demographic information. The method may further comprise, with respect to a set of user profiles associated with demographic information at least partially corresponding to the user demographic information, associating the summary media content with the media content and, in response to one or more users associated with at least one user profile of the set of user profiles interacting with the media content, outputting the summary media content, or a portion thereof, for display.

According to some implementations, a media system for generating summary media content may be provided. The media system may comprise one or more processors, and one or more memories in communication with the one or more processors. The one or more memories may comprise executable instructions that, when executed by the one or more processors, may perform an operation of receiving biometric information from a biometric sensor while a user is interacting with the media content output by the media system, using the biometric information received from the biometric sensor, identifying one or more periods of high user engagement between the user and the media content, the one or more periods of high user engagement corresponding to the biometric information meeting a threshold level of biometric activity, based on the identified one or more periods of high user engagement, selecting one or more media content portions of the media content corresponding to the one or more periods of high user engagement, and generating summary media content, the summary media content including at least the one or more media content portions without including portions of the media content that do not corresponding to the one or more periods of high user engagement.

In some embodiments, a media system may further comprise the biometric sensors configured to obtain the biometric information, the biometric sensor comprising at least one of: a camera, a grip strength sensor, a microphone, or a heartrate monitor. The camera may be configured to detect a facial expression of the user while the user is interacting with the media content. The executable instructions, when executed by the one or more processors, may further perform the operation of identifying an emotion based on the facial expression of the user.

The camera may be configured to detect an eye movement of the user while the user is interacting with the media content. The executable instructions, when executed by the one or more processors, may further perform the operation of identifying the one or more periods of high user engagement based on the eye movement of the user.

In some cases, the executable instructions, when executed by the one or more processors, may further perform the operation of identifying user demographic information of the user using a user profile associated with the user and associating the user demographic information with the one or more periods of high user engagement.

The executable instructions, when executed by the one or more processors, may further perform the operation of associating the one or more periods of high user engagement with additional user profiles that at least partially correspond to the user demographic information. The executable instructions, when executed by the one or more processors, may further perform the operation of generating a user engagement report, the user engagement report including at least the one or more periods of high user engagement.

According to some implementations, a method of providing summary media content to a user may be provided. The method may comprise outputting, by an electronic device, media content to a user, receiving, by the electronic device and from a biometric sensor, a signal corresponding to a biometric event, in response to receiving the signal, identifying, by the electronic device, a portion of the media content that is output by the electronic device during a time period corresponding to reception of the signal, and, using the portion of the media content, generating, by the electronic device, summary media content corresponding to a condensed version of the media content.

In some embodiments, the portion of the media content may comprise a first portion of the media content and a second portion of the media content, the first portion and the second portion occurring during discontinuous time periods. The first portion and the second portion are arranged consecutively within the summary media content.

In some embodiments, the portion of the media content may be a first portion of the media content and the signal corresponding to the biometric event may be a first signal corresponding to a first biometric event. The method may further comprise identifying, by the electronic device, a second portion of the media content based on a second signal corresponding to a second biometric event different from the first biometric event, determining, by the electronic device, that the second portion of the media content is marked with a restricted indicator, and preventing, by the electronic device, the second portion of the media content from being added to the summary media content. The restricted indicator may be applied to the second portion of the media content based on a machine learning process configured to identify key moments within the media content. The method may further comprise outputting, by the electronic device, the summary media content upon at least one of a conclusion of the media content or an interaction with the media content or an indicator of the media content.

### BRIEF DESCRIPTION OF THE DRAWINGS

Reference will now be made to representative embodiments illustrated in the accompanying figures. The following descriptions are not intended to limit the embodiments to one preferred embodiment. To the contrary, the disclosure is intended to cover alternatives, modifications, and equivalents as may be included within the spirit and scope of the described embodiments as defined by the appended claims. Identical reference numerals have been used, where possible, to designate features that are common to the figures.

FIG. 1 depicts an example system of distributing and providing media content, in addition to obtaining biometric information from a user interacting with the media content, as described herein.

FIGS. 2A-2D depict an example system for generating summary media content in response to a user engaging with media content, as measured from a biometric sensor, as described herein.

FIG. 3 depicts an example process of generating and causing display of summary media content in response to user activity, as described herein.

FIG. 4 depicts an example process of generating a user engagement report in response to monitoring a user's engagement with provided media content, as described herein.

FIG. 5 depicts an example process of providing summary media content based on a user's demographic information, as described herein.

The use of cross-hatching or shading in the accompanying figures is generally provided to clarify the boundaries between adjacent elements and to facilitate the legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, the proportions and dimensions (either relative or absolute) of the various features and elements (and collections and groupings thereof), and the boundaries, separations, and positional relationships presented therebetween, are provided in the accompanying figures to facilitate an understanding of the various embodiments described herein, may not necessarily be presented or illustrated to scale, and are not intended to indicate any preference or requirement for an illustrated embodiment to the exclusion of embodiments described with reference thereto.

### DETAILED DESCRIPTION

The following disclosure relates to various techniques for generating summary media content in response to user interactions with, and/or user emotional responses to, media content. As described herein, “summary media content” refers to condensed, remixed media material, and/or any media content that is derived from source material. A highlight reel and/or trailer are non-limiting examples of summary media content, as the term is used herein.

A user may engage with media content frequently throughout the course of the user's day-to-day life. For example, a user may engage with media content such as music, television programs, videos, movies, radio, audiobooks, and so on. However, after a certain amount of time has passed, the user may not clearly remember aspects of the previously consumed media. For example, the user may forget certain plotlines, characters, lyrics, events, and so on. Additionally, the user may want to re-engage with certain aspects of the media. For example, the user may want to view clips of her favorite scenes or hear clips of particularly newsworthy events. Yet further, the user may want a visual and/or audio summary of consumed media to use privately and/or share with others (e.g., over social media).

In some circumstances, a user may use specialized programs, such as video and/or audio editing software, to manually create condensed and/or remixed content. This kind of manually created condensed and/or remixed content may be created for streaming services and may be in the form of a trailer or teaser (e.g., as a thumbnail). However, such programs are often time consuming and/or require a certain amount of skill to create high quality condensed and/or remixed content. In addition, a user using these programs would be required to manually search for desired clips for inclusion in the condensed and/or remixed content, which may require significant time.

To eliminate or alleviate these concerns, the present disclosure discloses generating summary media content autonomously, or otherwise without direct user involvement, in accordance with a user's interaction with media. For example, summary media content may be generated without direct user involvement and through a user's interaction with the source media.

When a user interacts with media, the user may engage with the media and may exhibit physical characteristics indicative of an emotional response and/or high user engagement. For example, a sad scene in a movie may cause a user to cry or exhibit facial expressions related to sadness. In another example, an exciting scene may cause a user's heart to race.

As discussed herein, one or more biometric sensors may detect biometric information characteristic of emotional responses and/or high user engagement. Once detected, a system in accordance with the provided disclosure may determine which displayed scenes elicited these emotional responses and/or high user engagement and may store or otherwise create summary media content from those scenes or media portions, such as described herein.

The emotional response and/or high user engagement of the user may be ascertained from biometric information obtained from the user through use of one or more biometric sensors including, but not limited to, a camera, a heartrate monitor, a motion sensor, a microphone, or a grip strength detector. A camera, for example, may include facial recognition software and may be able to detect a user's emotional state or interest based on a facial expression, including those related to happiness, sadness, anger, excitedness, surprise, boredom, and so on. In an additional or alternative embodiment, a heartrate monitor may be able to detect a user's elevated heartrate, which may be in response to exciting and/or engaging media scenes. The biometric sensors may include biometric software, which may be used to identify periods of high user engagement based on, for example, a user's heartrate being above a threshold for a certain period of time. Other biometric sensors may also be used in accordance with the disclosure.

In some embodiments, a user engagement report may be created from the user biometric information. For example, user biometric information may correspond to user engagement (or lack thereof) while media content, such as programs or advertisements, is being presented to the user. The user engagement report may be used to determine the effectiveness of a media campaign or event.

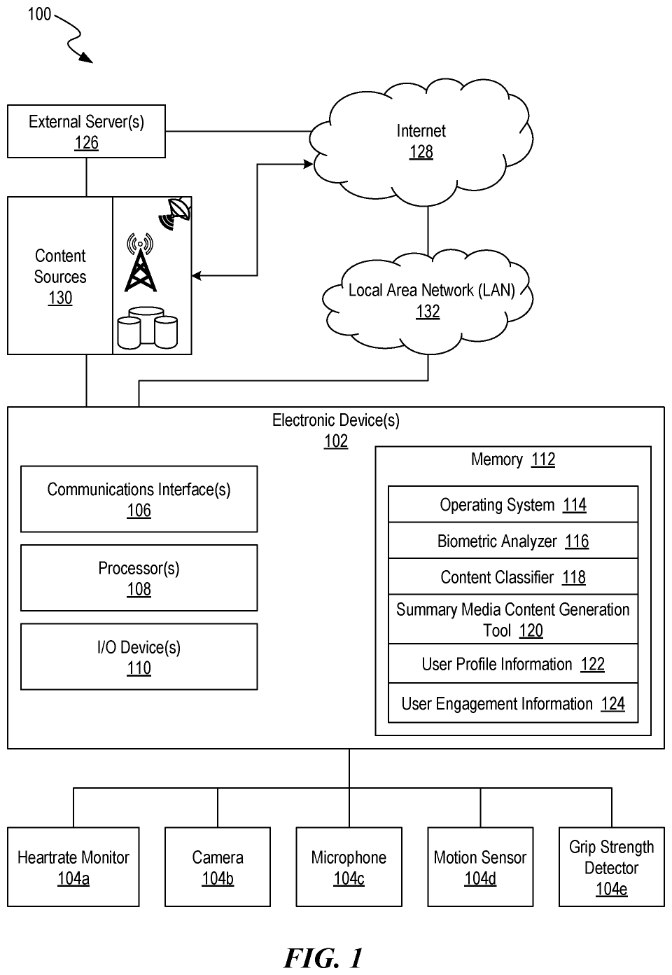

FIG. 1 depicts an example media system 100 for providing media content to an electronic device 102. The electronic device 102 may refer to any form of device that a user can use to access media. Non-limiting examples of electronic devices include cable/satellite set-top boxes, smart televisions, streaming devices, digital media players, laptop and desktop computers, radios, table computing devices, smartphones, gaming consoles, and so on. Though one electronic device is depicted in FIG. 1, it is appreciated that a media system 100 may provide media to any number of electronic devices, which may be the same or different types, either associated with the same user, different users, or collections of users.

The electronic device 102 may include a communications interface 106, a processor 108, and an input/output (I/O) device 110. As indicated in FIG. 1, the communications interface 106, processor 108, and I/O device 110 may, respectively, be one or more than one component (e.g., a processor 108 may be multiple processors). The depicted components are depicted only as non-limiting examples and additional, or fewer, components be used in any given electronic device. A component may be provided as integrated into the electronic device 102, directly coupled to the electronic device 102, or otherwise communicatively and/or operationally coupled to the electronic device 102.

The communications interface 106 may include one or more components for use in forming a network connection between a wireless/wired network, such as the Internet 128 and/or a local area network (LAN) 132, and the electronic device 102. The communications interface 106 is not limited to any particular technology and may include hardware and software configured for use with one or more of BLUETOOTH, ZIGBEE, near-field communication (NFC), narrowband Internet of things (IoT), WIFI, cellular (e.g., 3G, 4G, and LTE), a wired network, and other communications technologies. Any known or later arising networking and/or other communications technologies may be used to facilitate communications between the electronic device 102 over a network, such as the LAN 132 and/or the Internet 128. For some embodiments, the communications interface 106 may be used to transmit information across any number of networks, such that different information types are routed through different networks. As a non-limiting example, the communications interface 106 may be configured to receive media content via content sources 130 and may additionally be configured to transmit a user engagement report to a service provider, as discussed herein.

In some embodiments, the communications interface 106 may be configured to include one or more data ports for establishing connections between an electronic device 102 with a network, server, and/or service. Such data ports may support any technologies, such as universal serial bus (e.g., USB 2.0 and USB 3.0), ETHERNET, FIREWIRE, HDMI, wireless technologies, and so on. The communications interface 106 may be configured to support the transfer of data formatted using any desired protocol and at any desired data rates/speeds with respect to the electronic device 102. The communications interface 106 may be connected to one or more antennas to facilitate wireless data transfers. Such antennas may support short-range technologies, such as 802.11a/c/g/n and others, and/or long-range technologies, such as cellular, as non-limiting examples.

The processor 108 may control some or all of the operations of the electronic device 102. The processor 108 may communicate, either directly or indirectly, with some or all of the components of the electronic device 102 including, for example, a system bus or other communication mechanism, and may provide communication between, as non-limiting examples, the processor 108, the memory 112, the I/O device 110, and the communications interface 106.

The processor 108 may be implemented as any device capable of processing, receiving, or transmitting data or instructions. For example, the processor 108 may be a microprocessor, a central processing unit (CPU), an application-specific integrated circuit (ASIC), a digital signal processor (DSP), or combinations of such devices. As described herein, the term “processor” may encompass a single processor or processing unit, multiple processors, multiple processing units, or other suitably configured computing element or elements.

Components of the electronic device 102 may be controlled by multiple processing units. For example, some components of the electronic device 102 may be controlled by a first processing unit and other components may be controlled by a second processing unit, where the first and second processing units may or may not be in communication with each other. In some cases, the processor 108 may determine a biological parameter of a user of the electronic device, such as a biometric response of a user as received from the biometric sensor 104a-104e.

The electronic device 102 may also include an I/O device 110, which may refer to one or more I/O devices. In various embodiments, the I/O device 110 may include any suitable components for detecting inputs. Examples of an I/O devices 110 include mechanical devices (e.g., switches, buttons, and keys), communication devices (e.g., wired and wireless communication devices), electrodes, one or more displays, some combination thereof, and so on. Each I/O device 110 may be configured to detect one or more particular types of input and provide a signal corresponding to the detected input. The signal may be provided, for example, to the processor 108.

As discussed herein, in some cases, the I/O device 110 includes a touch sensor (e.g., a capacitive touch sensor) integrated with a display to provide a touch-sensitive display. Similarly, in some cases, the I/O device 110 includes a force sensor (e.g., a capacitive force sensor) integrated with a display to provide a force-sensitive display. As discussed herein, a display may be considered a type of I/O device 110 and may be configured to provide visual information to a user.

The I/O device 110 may further include any suitable components for providing outputs. Examples of such I/O devices include audio output devices (e.g., speakers), visual output devices (e.g., lights or displays), tactile output devices (e.g., haptic output devices), communication devices (e.g., wired and wireless communication devices), displays, some combination thereof, and so on. Each I/O device 110 may be configured to receive one or more signals and provide an output corresponding to the signal.

In some cases, the I/O device 110 may be integrated as a single device or may be separate devices. For example, an I/O device or port can transmit electronic signals via a communications network, such as a wireless and/or wired network connection (e.g., via the communications interface 106).

The processor 108 may be operably coupled to the I/O device 110 and may be adapted to exchange signals with the I/O device 110. For example, the processor 108 may receive an input signal from an I/O device 110 that corresponds to an input detected by the I/O device 110. The processor 108 may interpret the received input signal to determine whether to provide and/or change one or more outputs in response to the input signal. The processor 108 may then send an output signal to one or more of the I/O devices, to provide and/or change outputs as appropriate.

An example of an I/O device is a display, which may provide a graphical output, for example, associated with an operating system, user interface, and/or applications of the electronic device 102. In some embodiments, the display may include one or more sensors and is configured as a touch-sensitive (e.g., single-touch, multi-touch) and/or force-sensitive display to receive inputs from a user. For example, the display may be integrated with a touch sensor (e.g., a capacitive touch sensor) and/or a force sensor to provide a touch- and/or force-sensitive display. The display may be operably coupled to the processor 108 of the electronic device 102.

The display may be implemented with any suitable technology, including, but not limited to, liquid crystal display (LCD) technology, light emitting diode (LED) technology, organic light emitting display (OLED) technology, organic electroluminescence (OEL) technology, or another type of display technology. In some cases, the display may be positioned beneath and viewable through a cover that forms at least a portion of an enclosure of the electronic device 102. Some displays also include touch screen functionality where a user may exert a touch and/or a force on a touch-sensitive display to interact with an electronic device via the display. In some embodiments, the electronic device 102 does not include any display. In such embodiments, the electronic device 102 may be coupled to other electronic devices that include a display and may at least partially control operations of the other electronic devices. In various embodiments, the electronic device 102 does not include any display and may instead be coupled to a separate display.

The memory 112 may store electronic data that can be used by the electronic device 102 and/or the processor 108. For example, the memory 112 may store electrical data or content such as, for example, audio and video files, applications, device settings and user preferences, timing signals, control signals, and data structures or databases. The memory 112 may be configured as any type of memory. By way of example only, the memory 112 may be implemented as random access memory (RAM), read-only memory (ROM), flash memory, removable memory, other types of storage elements, or combinations of such devices. The memory 112 may comprise one or more memory modules and may be in any number of forms (e.g., permanent or temporary memory). The memory 112 may be any combination of working memory or storage memory.

The memory 112 may include software instructions and/or data for, as a non-limiting example, an operating system 114, a biometric analyzer 116, a content classifier 118, a summary media content generation tool 120, user profile information 122, and user engagement information 124. With respect to the specific modules depicted in FIG. 1, some, or all, of these modules may be optional and may be eliminated in some embodiments. Additionally, additional modules may be provided and components of the memory 112 are not limited to any specific configuration (and components of the memory 112 may be constantly changing due to, for example, personalization by a user). The modules depicted in the memory 112 are not necessarily distinct and may refer to components of the same program. Additionally, each of the depicted, and undepicted, modules may communicate with each other.

The operating system 114 may reference system software installed with respect to the electronic device 102 that manages hardware and software resources of the electronic device 102. The operating system 114 is not limited to any particular operating system and may include operating systems designed for mobile devices, personal computing devices, set-top box devices, televisions, digital media players, and so on.

The biometric analyzer 116 may refer to software and/or hardware components configured to perform biometric analysis on incoming biometric information, as discussed herein. For example, the biometric analyzer 116 may comprise a software program configured to determine a user's emotional state and/or engagement based on a facial expression of the user (e.g., facial detection software) and/or may comprise a software program configured to analyze a user's heartrate. The biometric analyzer 116 may include any algorithms (including machine learning algorithms) configured to analyze biometric information and to identify information about a user's emotional state from associated biometric analysis.

The content classifier 118 may refer to software and/or hardware components configured to analyze media content and to categorize the media content based on a number of factors, including presence of introduction graphics or videos, spoiler content, actors present in a scene, mature content warnings, and so on. The content classifier 118 may include machine learning algorithms to identify portions of media content based on, for example, visual or audio information (though machine learning algorithms are optional and non-machine learning techniques may be used in additional or alternative embodiments). As a non-limiting example, the content classifier 118 may determine whether a portion of the media content is an introduction, such as a theme song, and may automatically skip the indicated portion. In another non-limiting example, the content classifier 118 may use facial recognition elements to mark when particular actors are present within a scene. In some embodiments, the content classifier 118 may communicate with the biometric analyzer 116 to determine which portions of media content are associated with a user's biometric response and/or engagement. In some embodiments, the content classifier 118 may include software for manually marking and/or associating tags with portions of media content (e.g., by indicating whether a scene contains spoilers or plot-sensitive content) which may be used by the summary media content generation tool 120, as discussed below.

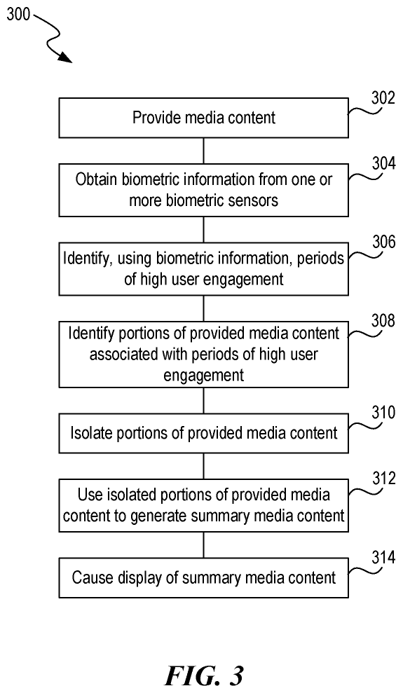

The summary media content generation tool 120 may refer to software and/or hardware components configured to generate summary media content (see, e.g., FIG. 3 for an example method of generating summary media content). The summary media content generation tool 120 may use information from the biometric analyzer 116 and/or content classifier 118 to generate summary media content that is a summary or condensed version of original media content. The summary media content generation tool 120 may be configured to generate summary media content that is specific to an individual user, for example, based on that specific user's biometric response and/or engagement to certain scenes. However, in some embodiments, the summary media content may be shared with other users, such as users sharing some similarities, such as demographics, with the user for whom the summary media content was generated.

The summary media content generation tool 120 may isolate portions, or scenes, of media content and may provide those isolated portions within a condensed presentation and/or highlight reel. In a non-limiting example, the summary media content generation tool 120 may use portions of a basketball game, related to, for example, important score changes, to create a condensed summary. In some embodiments, the summary media content generation tool 120 may use one or more transitions, or special effects, that are not necessarily present in the source material. For example, when moving between scenes in summary media content, the summary media content generation tool 120 may insert fade-out or fade-in transitions (with respect to audio and/or video), wipes, or other graphical features, including, but not limited to, animations or text overlay.

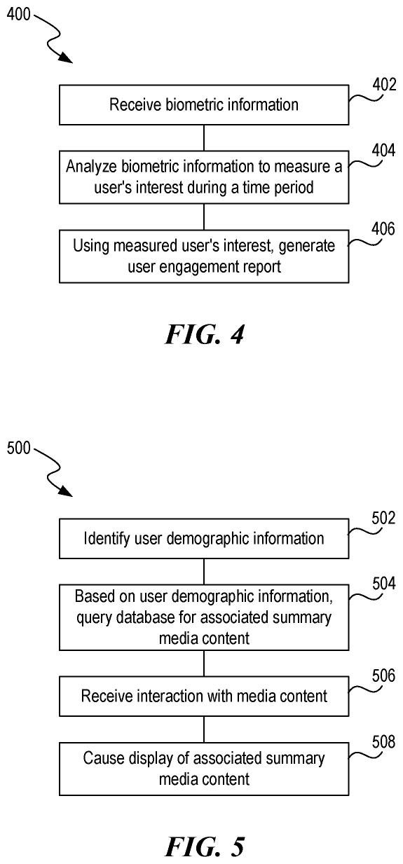

The user profile information 122 may include information concerning a user profile of one of more users of the electronic device 102. The user profile information 122 may include information related to any number of relevant information, such as subscription information and user demographic information. The user profile information 122 may be stored locally on the electronic device 102 and/or may be transmitted to, or received from, a central database via the communications interface 106. The user engagement information 124 may be used to generate a user engagement report, as discussed with respect to FIG. 4. The user engagement information 124 may correspond to a user's biometric information with respect to the provided media content and/or may contain information related to a user's emotional tendencies/engagement while interacting with media. In some embodiments, user biometric information may be stored within at least one of the user profile information 122 or the user engagement information 124.

The electronic device 102 may be communicatively coupled to content sources 130 and one or more external servers 126 via networks such as the Internet 128. The content sources 130 may include, but are not limited to, satellite or cable distribution services such as those provided by cable or satellite service providers. In additional or alternative embodiments, the content sources 130 may be terrestrial content broadcasters, such as those provided by local television stations, streaming content providers (e.g., NETFLIX, SLING, and YOUTUBE), over the top sources, and so on. The content sources 130 are not particularly limited and may include any audio and/or video service provider. The external servers 126 may refer to one or more servers (e.g., data servers) that store content (e.g., a computer hard drive).

In some embodiments, the electronic device 102 may be communicatively coupled to a LAN 132 by one or more internal links. The LAN 132 may be configured for use within a single household or may be configured for use with two or more households, as may arise in a multi-unit dwelling. When two or more households are communicatively coupled using the LAN 132, appropriate firewalls and other logical and/or physical separations may be provided between such households. The internal links may use any desired known and/or later arising wired, wireless, and/or combinations thereof, communications and network technologies; non-limiting examples include WIFI, ETHERNET, coaxial cables, BLUETOOTH, fiber optic cables, and so on. As discussed further below, the LAN 132 provides a communications pathway by which the electronic device 102 communicates with other local devices. The LAN 132 may have a name or SSID associated with it. The name may be hidden or publicly detected.

Using the LAN 132, a common universal directory of recorded content across two or more connected electronic devices within a given household may be populated. Such populated content may be seamlessly accessible by one or more of the electronic devices, even when such content is not directly stored using a memory provided by that given electronic device. That is, for at least some embodiments, content populated onto a universal directory from multiple electronic devices may be shared and accessible by and between two or more of the various electronic devices then communicatively coupled to a given LAN 132, where each such electronic device is configured to facilitate content sharing over that LAN 132.

As depicted in FIG. 1, the electronic device 102 may be communicatively coupled with a number of biometric sensors 104a-104e for obtaining biometric information from a user. The biometric sensors 104a-104e may include a heartrate monitor 104a, a camera 104b, a microphone 104c, a motion sensor 104d, and/or a grip strength detector 104e. A biometric sensor, in accordance with the provided disclosure, is not limited to the devices depicted in FIG. 1, however, and may include any type of biometric sensor including, but not limited to, fingerprint or palmprint sensors, optical sensors, proximity sensors, and so on.

The biometric sensors 104a-104e may be used to obtain biometric information from a user. For example, the heartrate monitor 104a may be a finger-worn device configured to detect user blood flow. The heartrate monitor 104a may, in alternative embodiments, be a camera, such as an infrared camera, configured to detect heartrate. The heartrate monitor 104a may be any device or sensor configured to detect a user's heartrate (e.g., directly or by detecting a user's breathing rate). Similarly, the biometric sensors 104b-104e (e.g., camera 104b, microphone 104c, motion sensor 104d, and grip strength detector 104e) may be any device configured to obtain user biometric information. The biometric sensors 104a-104e may be used to perform facial recognition, proximity sensing, voice recognition, and so on. In some embodiments, the biometric sensors 104a-104e may be integrated with another object. For example, a grip strength detector 104e may be a stress/strain sensor integrated within a television remote control. Though depicted as separate from the electronic device 102 in FIG. 1, in some implementations the biometric sensors 104a-104e may be integrated with the electronic device 102.

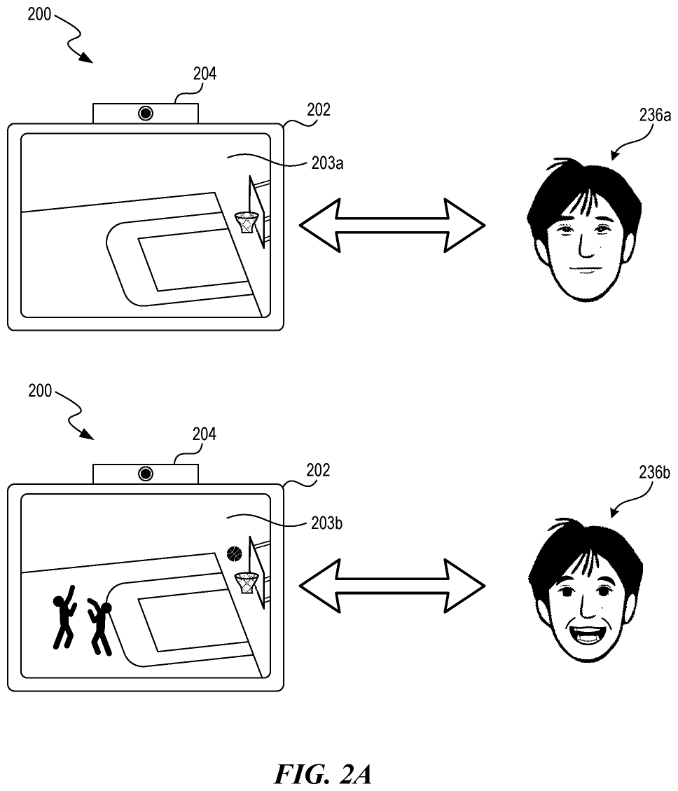

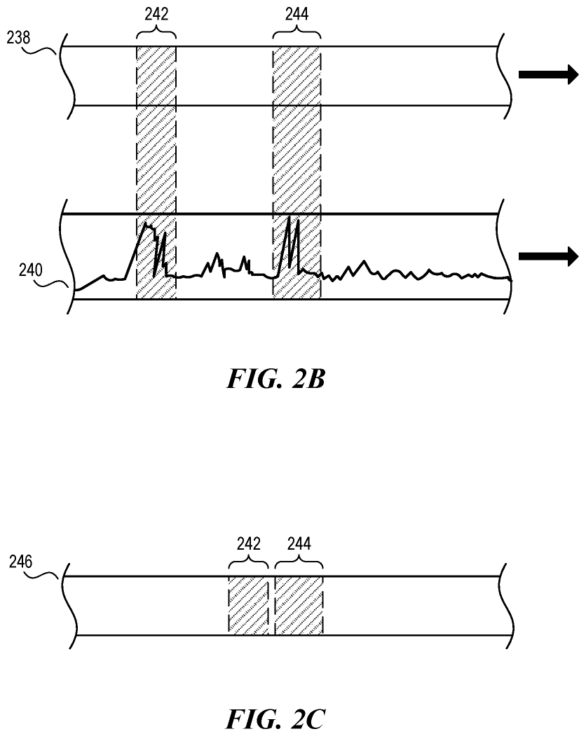

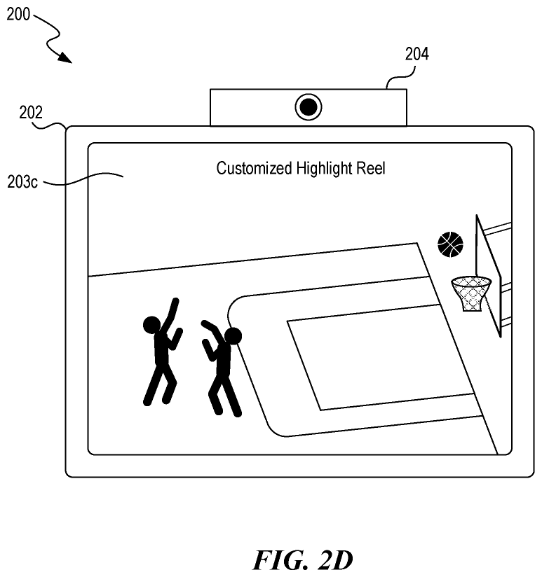

FIGS. 2A-2D depict an example media system 200 for presenting media to a user. The media system 200 is merely one example and any number of media systems (including media systems configured to solely provide audio information) may be used in accordance with the disclosure.

FIG. 2A depicts the media system 200, including an electronic device 202 (e.g., a television) and a camera 204 as an example of a biometric sensor. As discussed above with respect to FIG. 1, the camera 204 is only one example of a biometric sensor and any device configured to obtain biometric information from a user may be used in accordance with the media system 200.

During an operation of the media system 200, media content (e.g., first media content portion 203a) may be provided to a user. In FIG. 2A, the first media content portion 203a may be a relatively unexciting portion of the media content, such as a basketball game when no action is occurring. The camera 204 may be configured to detect a user's facial expression while the user is interacting with the media content. In the example depicted, the camera 204 may detect a neutral expression 236a of the user while the user is engaging with the first media content portion 203a. In some embodiments, the camera 204 may detect eye movement of the user. The eye movement information may be used to track or otherwise measure user interest and/or user engagement.

At certain points, the user may engage with the media content during, for example, exciting moments. This user engagement may be evident from physical characteristics of the user, such as an increased heartrate, a change in facial expression, or a change in grip strength. In the example depicted in FIG. 2A, a second media content portion 203b may be provided while the media system 200 is providing media content. The second media content portion 203b may be depicting a moment that a user considers exciting, such as a last-second shot in a basketball game. When viewing this second media content portion 203b, therefore, the user's facial expression may change to one indicative of excitement and the camera 204 may detect the user's excited expression 236b. In this way, as an example, the camera 204 (or any biometric sensor) may monitor a user's activity during portions of the provided media content.

FIG. 2B depicts an example representation of media content 238 and a chart 240 representing a user's biometric reactions and/or engagement to the media content 238. While media content 238 is provided to a user, the user may react during certain portions of the media content 238, as discussed herein. The user's reactions while interacting with the media content 238 may be detected by biometric sensors, as discussed above with respect to FIGS. 1 and 2A. The user's reactions may be obtained by the biometric sensors and may be converted into values which can be displayed graphically, though graphic representation of biometric values is not required and is provided in FIG. 2B for the sake of visual representation.

During certain time periods, a user's biometric information, as obtained from biometric sensors, may be indicative of emotional responses and/or user engagement. In the chart 240, for example, a user's heartrate spikes during a first time period 242, corresponding to a first portion of media content, and during a second time period 244, corresponding to a second portion of media content. In some embodiments, this spike may be identified by detecting when a user's heartrate spikes above a certain threshold level. In other examples, a user's emotional response may be identified through biometric analysis of facial expressions, grip strength, and/or iris movement. The user's biometric information may be continuously monitored, as depicted in FIG. 2B. In other embodiments, the user's biometric information may be detected only at times when a biometric signal is received from a biometric sensor. For example, a remote control may include a stress/strain sensor and the remote control may transmit a signal when a sufficient force is received at the remote control. The signal may correspond to a biometric event, which may refer to the sufficient force being detected by, for example, the remote control. A biometric event may refer to any event corresponding to a user's activities. Examples of a biometric events include squeezing a force sensor with sufficient force, pressing a button, a certain heartrate value being reached, a threshold activity level being reached (e.g., a heartrate reaching a certain value), and so on.

As depicted in FIG. 2C, the portions of the media content corresponding to periods of elevated heartrate (e.g., during the first time period 242 and the second time period 244) may be extracted and/or isolated and may be placed within summary media content stream 246. The respective portions may be placed consecutively, as depicted in FIG. 2C, or may be placed non-consecutively. In some embodiments, generated graphical elements may separate portions of the media content (e.g., transitions or animations). The summary media content stream 246 may be completed when all portions, or a subset thereof, of media content corresponding to biometric responses and/or user engagement are provided within the summary media content stream 246.

FIG. 2D depicts an example of the summary media content 203c as displayed on an electronic device 202. The summary media content 203c may display only those portions of media content which invoked an emotional response and/or engagement from the user. In this way, the user may be provided with customized summary media content based on the user's own interactions with media content. In some embodiments, the electronic device 202 may be a device that does not include a display. In such embodiments, the electronic device 202 may be coupled to another electronic device with a display.

In some embodiments, software and/or hardware may be provided to distinguish positive emotional reactions from negative emotional reactions. For example, a certain scene may invoke a strong emotional reaction related to a negative emotion, such as disgust or annoyance. A user may not want to relive these negative emotions. In certain situations, therefore, the summary media content 203c may only be populated with scenes that invoke positive emotional reactions. In some cases, summary media content may be populated with scenes invoking a specific kind of emotion. For example, summary media content exclusively directed to anger may be exclusively populated with scenes that invoke a user's anger reaction, as detected by biometric devices. Such summary media content may be generated from any emotional response, including, but not limited to, positive or negative emotional responses.

The summary media content 203c may be displayed on an electronic device 202 at the conclusion of the original media content. For example, after the conclusion of a basketball game, the summary media content 203c may be provided as a recap. In additional or alternative embodiments, the summary media content 203c may be provided upon user interaction with a graphical representation, such as a pop-up or in-screen thumbnail. For example, if a user has watched a television program before and interacts with the television program thumbnail through a streaming service or storage device, the previously generated summary media content 203c may be displayed across an entire display of an electronic device or otherwise coupled to an electronic device.

In some embodiments, the summary media content 203c is locally stored on a user's electronic device 202. In additional or alternative cases, the summary media content 203c may be provided on cloud storage and may be accessible through a paid or free service. The summary media content 203c may be private for a particular user or may be shareable to others in a user's social network.

In some embodiments, threshold parameters in determining when a user is displaying an emotional response and/or engagement (e.g., threshold levels of activity) may be automatically or manually modified by a particular user or service. For example, a user who typically exhibits relatively subtle emotional responses may have a threshold lower than another user who exhibits exaggerated emotional responses. Any manner of modifying threshold parameters may be used in accordance with the disclosure. For example, threshold parameters may be in the form of editable numbers or bar sliders. In other examples, threshold parameters may be automatically selected through machine learning processes (e.g., based on prior biometric information obtained from a user). In some embodiments, the threshold parameters are not editable and are the same for every user.

FIG. 3 depicts a flowchart of an example process 300 for generating and causing display of summary media content. As discussed herein, summary media content may refer to media content that is condensed and/or abbreviated to, for example, contain only those moments of media content to which a user experiences an emotional reaction and/or high engagement.

At operation 302, media content may be provided to a user. As discussed herein, media content may be provided through any one of a number of different electronic devices, including, but not limited to, televisions, set-top boxes, digital media players, desktop computers, augmented reality and/or virtual reality enabled headsets, and smart phones. The media content may be provided in any form, including, but not limited to, video, augmented reality, audio, any combination thereof, and so on. For the sake of clarity, process 300 will be described with respect to visual images and sound as, for example, provided through a television, though process 300 is not so limited.

At operation 304, a user's biometric characteristics are measured by obtaining biometric information from one or more biometric sensors. As a user is interacting with media content, the user may exhibit physical characteristics indicative of an emotional response to and/or engagement with the media content. During an action scene, for example, the user's heartrate may increase. The user's heartrate increase may be detected by, for example, a heartrate monitor. In some embodiments, the user's heartrate may be detected by a camera which may detect a user's breathing rate and may use software to estimate or determine a user's heartrate from their breathing rate.

As discussed with respect to FIG. 1, the biometric sensors are not particularly limited. In some embodiments, a remote control may include a stress/strain detector and may detect when a user is squeezing the remote control. In other cases, the biometric sensor may be a camera and may continuously monitor the user for emotional reactions and/or engagement. Any other biometric sensor may be used in accordance with process 300.

At operation 306, periods of high user engagement may be identified using the biometric information obtained at operation 304. Periods of high user engagement may refer to periods when biometric information concerning a user is at or above a threshold value. For example, a period of high user engagement may refer to periods when a user's heartrate is at or above a threshold value. The period of high user engagement may refer to when received biometric information meets a threshold level of biometric activity, such as discussed with respect to FIGS. 2A-2D. In some embodiments, periods of high user engagement may refer to periods when a user is exhibiting certain facial expressions, which may be measured by an optical sensor, such as a camera, and as depicted in FIG. 2A.

As discussed, at operation 306 one or more periods of high user engagement, corresponding to one or more scenes or portions of media content, may be identified. These periods may be continuous or discontinuous, depending on when the user exhibits certain physical characteristics as determined from the user's biometric information.

In some embodiments, a biometric response of the user while the media content is provided/displayed is continuously monitored to detect user activity over time. To determine periods of high user engagement, the process 300 may determine when the biometric response of the user reaches a threshold value. When the biometric response of the user reaches a threshold value, the one or more periods of high user engagement may be identified. In other embodiments, the user is not continuously monitored and the system receives a signal when a biometric sensor detects a threshold level of activity.

At operation 308, portions of the provided media content associated with periods of high user engagement may be identified. With reference to FIG. 2B, the portions of media content may be identified in accordance with a time window associated with the periods of high user engagement. In some embodiments, the portions of the provided media content may correspond to precisely when the user is exhibiting high user engagement. In some cases, the portions of media content may correspond to scenes in which the user exhibited high user engagement, even if high user engagement was not detected throughout the entire scene. In such cases, context may be provided within the generated summary media content by providing an entire scene.

At operation 310, the identified portions of the provided media content may be isolated. In some cases, the identified portions may be stored in permanent or temporary storage (e.g., a datastore). The identified portions may be permanently or temporarily placed in a summary media content container, such as depicted in FIG. 2C. The identified portions may be isolated in a native media format. In some cases, the identified portions may be modified, such as with the addition of a filter.

At operation 312, the isolated portions may be used to generate summary media content. As discussed herein, the summary media content may be a summary or condensed version of the originally provided media content and may contain portions that elicited an emotional response from a user (corresponding to periods of high user engagement). The summary media content may be stored (e.g., in a datastore) and may be accessible such as, for example, when a user interacts with a media thumbnail.

At operation 314, the summary media content is displayed. The manner in which the summary media content is displayed is not particularly limited. For example, the summary media content may be displayed on a television display after the conclusion of the media event. In other examples, the summary media content may be displayed when the user interacts with the program at a later time (e.g., by interacting with a thumbnail or the program on television guide software). In some examples, an electronic device without a display may cause another electronic device to display the summary media content.

In some cases, the summary media content may be provided to those other than the user from whom biometric information was obtained. For example, the summary media content may be provided to others within a user's network (e.g., social media network) when they interact with an indicator of the corresponding media content. In additional or alternative embodiments, the summary media content may be provided to those sharing some aspect of the user's demographic information. Portions of the summary media content may be removed or censored to remove, for example, spoiler information.

FIG. 4 depicts an example process 400 of generating a user engagement report in response to provided media content. A user engagement report may be used by a producer and/or interested party of the media content to determine the effectiveness of a piece of media. For example, a user engagement report may be used to monitor a user's interest during a commercial or advertising campaign to determine whether the goals of the commercial or advertising campaign are being met.

At operation 402, after media content is displayed to a user, biometric information concerning a user's reaction to the media content may be received. For example, one or more biometric sensors may receive biometric information corresponding to emotional responses/physical characteristics of a user as described herein. The biometric information may be monitored continuously, without any associated threshold value, to obtain biometric information related to the entire time that a user is interacting with media content.

At operation 404, the biometric information received from the user is analyzed (e.g., through biometric analysis techniques) to measure a user's interest during a time period. The time period may correspond to a length of time that the media content is being displayed, any portion thereof, and/or any combination of media content (e.g., including programming and commercial breaks).

At operation 406, a user engagement report may be generated using the measured user's interest. The form of the user engagement report is not particularly limited and may include text, graphs, equations, scores, and so on. Any content included within the user engagement report may be auto-generated according to previously created templates. These previously created templates may include lines of text and/or graphics that are added to the user engagement report when a certain biometric threshold is reached. In a non-limiting example, if a user has been looking at the media content for at least 90% of the duration of the media content, as detected by a camera and/or eye tracking software, a phrase such as: “The user exhibited substantial focus on the media content” may be included within the user engagement report.

The user engagement report may be directed to the engagement of one user (e.g., an individual) or may be based on the collective viewing habits of many users. If directed to many users, the user engagement report may include additional breakdowns of user viewing habit by user category, which may be based on user demographic information.

The user engagement report may be transmitted from an electronic device displaying the media content to a centralized location for use by a distributer, or any other organization which may use the user engagement report. The user engagement report may be transmitted, for example, over a network such as the Internet. In some cases, the user engagement report is hidden from the user, but in other cases, the user engagement report may be accessible through a user interface of the electronic device. In some embodiments, biometric information may be transmitted to a centralized location and the user engagement report may be generated at the centralized location rather than being generated at the user's electronic device.

FIG. 5 depicts an example process 500 of providing summary media content to users other than the user for whom the summary media content was generated. At operation 502, user demographic information may be identified for a user. The user demographic information may be identified from, for example, a user profile and/or may be estimated based on viewing habits of the user. In some embodiments, the user's demographic information may be identified or estimated from the biometric sensors discussed herein. Examples of user demographic information are not particularly limited and may include information such as a user's gender, race, geographic location, age, and so on.

At operation 504, the process 500 may query external databases (e.g., over a network such as a LAN or the Internet) using the user demographic information. In this query, the user demographic information of the user may be used to identify other user profiles of users that share one of more characteristics indicated within the user demographic information. The external database may be, in some examples, in the control of a content provider who controls a service that displays the media content. The number of matches between the user demographic information and other user demographic information is not particularly limited and may be one or any number of matches. In some cases, the individual pieces of demographic content may be weighed differently, either alone or in combination. For example, a location information may be weighed more heavily than a user's age, though the disclosure is not limited to any specific weighing.

At operation 506, a device performing process 500 may receive an indication of an interaction with a piece of media content. Though operation 506 is depicted as occurring after operations 502 and 504, the timing of operation 506 may occur at any time, such as before at least one of operations 502 and 504.

At operation 506, a user may interact with a piece of media content by, for example, clicking on a thumbnail and/or accessing a particular television channel. The process 500 may identify, based on the user demographic information, whether summary media content exists, or is relevant, to that particular media content. If no summary media content is available, or relevant, then no summary media content may be displayed to the user. If relevant summary media content is available, then, at operation 508, the summary media content may be displayed to the user.

As described above, one aspect of the present technology is the gathering and use of biometric data to provide, for example, summary media content based on a user's biometric information. The present disclosure contemplates that, in some instances, this gathered data may include personal information data that uniquely identifies, may be used to identify and/or authenticate, or can be used to contact or locate a specific person. Such personal information data can include facial information, location information, or heartrate information.

The present disclosure recognizes that the use of such personal information data, in the present technology, can be used to the benefit of users. For example, the facial recognition data may be used to generate summary media content for the benefit of a user.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining the privacy and security of personal information. Such policies should be easily accessible by users, and should be updated as the collection and/or use of data changes. In various situations considered by the disclosure, personal information data may be entirely stored within a user device.

Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, collection of or access to certain health data, such as heartrate information, may be governed by federal and/or state laws, such as the Health Insurance Portability and Accountability Act.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of facial recognition or heartrate monitoring, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon first accessing a service that their personal information data will be accessed.

Moreover, it is the intent of the present disclosure that biometric information should be managed and handled in a way that minimizes the risk of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored, controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, generating summary media content may be based on direct user interaction, such as by manually pressing a physical or graphical button when the user wishes to indicate a response to a scene.

The foregoing description, for purposes of explanation, uses specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

As used herein, the phrase “at least one of” preceding a series of items, with the term “and” or “or” to separate any of the items, modifies the list as a whole, rather than each member of the list. The phrase “at least one of” does not require selection of at least one of each item listed. Instead, the phrase allows a meaning that includes one of any of the items, one of any combination of the items, and/or one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a list provided herein should not be construed as limiting the disclosure to only that order provided.

What is claimed is:

1. A method of generating summary media content, the method comprising:
outputting, by an electronic device, media content for display to a user;
receiving, by the electronic device, biometric information of the user from a biometric sensor while the media content is output for display;
identifying, by the electronic device, one or more periods of high user engagement with the media content based on the biometric information received from the biometric sensor, the one or more periods of high user engagement associated with at least one media content portion of the media content;
isolating, by the electronic device, the at least one media content portion from the media content;
generating, by the electronic device, summary media content including the at least one isolated media content portion; and
outputting, by the electronic device, the summary media content for display.

2. The method of claim 1, wherein identifying the one or more periods of high user engagement comprises:
determining, by the electronic device, when the biometric information of the user reaches a threshold value; and
in accordance with the biometric information of the user reaching the threshold value, identifying, by the electronic device, the one or more periods of high user engagement.

3. The method of claim 1, wherein:
the biometric sensor is an optical sensor configured to detect a certain facial expression of the user; and
the one or more periods of high user engagement correspond to periods when the user is exhibiting the certain facial expression.

4. The method of claim 3, wherein the certain facial expression of the user corresponds to at least one of: happiness, sadness, anger, excitedness, or surprise.

5. The method of claim 1, wherein:
the biometric sensor is a heartrate monitor configured to monitor a heartrate of the user; and
the one or more periods of high user engagement corresponds to periods when the user is experiencing an elevated heartrate.

6. The method of claim 1, wherein outputting the summary media content for display comprises outputting, by the electronic device, the summary media content for display when the user interacts with a graphical representation of the media content.

7. The method of claim 1, further comprising:
with respect to a user profile of the user, associating, by the electronic device, the summary media content with the media content; and
when the user profile of the user is active, outputting, by the electronic device, the summary media content, or a portion thereof, in response to an interaction with the media content.

8. The method of claim 1, wherein:
the user is associated with user demographic information; and
the method further comprises:
with respect to a set of user profiles associated with demographic information at least partially corresponding to the user demographic information, associating the summary media content with the media content; and
in response to one or more users associated with at least one user profile of the set of user profiles interacting with the media content, outputting the summary media content, or a portion thereof, for display.

9. A media system for generating summary media content, the media system comprising:
one or more processors; and
one or more memories in communication with the one or more processors, the one or more memories comprising executable instructions that, when executed by the one or more processors, perform an operation of:
receiving biometric information from a biometric sensor while a user is interacting with media content output by the media system;
using the biometric information received from the biometric sensor, identifying one or more periods of high user engagement between the user and the media content, the one or more periods of high user engagement corresponding to the biometric information meeting a threshold level of biometric activity;
based on the identified one or more periods of high user engagement, selecting one or more media content portions of the media content corresponding to the one or more periods of high user engagement; and
generating summary media content, the summary media content including at least the one or more media content portions without including additional portions of the media content that do not correspond to the one or more periods of high user engagement.

10. The media system of claim 9, further comprising the biometric sensor configured to obtain the biometric information, the biometric sensor comprising at least one of: a camera, a grip strength sensor, a microphone, or a heartrate monitor.

11. The media system of claim 10, wherein:
the camera is configured to detect a facial expression of the user while the user is interacting with the media content; and
the executable instructions, when executed by the one or more processors, further perform the operation of identifying an emotion based on the facial expression of the user.

12. The media system of claim 10, wherein:
the camera is configured to detect an eye movement of the user while the user is interacting with the media content; and
the executable instructions, when executed by the one or more processors, further perform the operation of identifying the one or more periods of high user engagement based on the eye movement of the user.

13. The media system of claim 9, wherein the executable instructions, when executed by the one or more processors, further perform the operation of:
identifying user demographic information of the user using a user profile associated with the user; and
associating the user demographic information with the one or more periods of high user engagement.

14. The media system of claim 13, wherein the executable instructions, when executed by the one or more processors, further perform the operation of associating the one or more periods of high user engagement with additional user profiles that at least partially correspond to the user demographic information.

15. The media system of claim 9, wherein the executable instructions, when executed by the one or more processors, further perform the operation of generating a user engagement report, the user engagement report including at least the one or more periods of high user engagement.

16. A method of providing summary media content, the method comprising:
outputting, by an electronic device, media content to a user;
receiving, by the electronic device and from a biometric sensor, a signal corresponding to a biometric event;
in response to receiving the signal, identifying, by the electronic device, a portion of the media content that is output by the electronic device during a time period corresponding to reception of the signal; and
using the portion of the media content, generating, by the electronic device, summary media content corresponding to a condensed version of the media content.

17. The method of claim 16, wherein:
the portion of the media content comprises a first portion of the media content and a second portion of the media content, the first portion and the second portion occurring during discontinuous time periods; and
the first portion and the second portion are arranged consecutively within the summary media content.

18. The method of claim 16, wherein:
the portion of the media content is a first portion of the media content and the signal corresponding to the biometric event is a first signal corresponding to a first biometric event; and
the method further comprises:
identifying, by the electronic device, a second portion of the media content based on a second signal corresponding to a second biometric event different from the first biometric event;
determining, by the electronic device, that the second portion of the media content is marked with a restricted indicator; and
preventing, by the electronic device, the second portion of the media content from being added to the summary media content.

19. The method of claim 18, wherein the restricted indicator is applied to the second portion of the media content based on a machine learning process configured to identify key moments within the media content.

20. The method of claim 16, further comprising outputting, by the electronic device, the summary media content upon at least one of a conclusion of the media content or an interaction with the media content or an indicator of the media content.
